(19) United States
(12) Patent Application Publication
(10) Pub. No.: US 2016/0112574 A1
(43) Pub. Date: Apr. 21, 2016

(54) AUDIO CONFERENCING SYSTEM FOR OFFICE FURNITURE

(71) Applicant: OFS Brands, Inc., Huntingburg, IN (US)

(72) Inventors: Wes Harper, North Augusta, SC (US); Jack Gershfeld, Fullerton, CA (US)

(73) Assignee: OFS Brands, Inc., Huntingburg, IN (US)

(21) Appl. No.: 14/516,045

(22) Filed: Oct. 16, 2014

(51) Int. Cl. H04M 3/56; H04W 4/16; A47B 21/06; H04W 4/00

(52) U.S. Cl. CPC H04M 3/568; H04W 4/008; H04W 4/16; A47B 21/06; A47B 2021/066

(57) ABSTRACT

An office furniture conferencing system includes a plurality of microphones attached to a table. Each microphone produces a respective audio signal. An electronic control module is attached to the table. The module includes a switching device having a plurality of inputs each receiving a respective one of the audio signals. The switching device selects and outputs one of the audio signals. A wireless transmitter is communicatively coupled to the switching device. The wireless transmitter wirelessly transmits an airborne signal dependent upon the selected audio signal.

### FIELD

The present invention relates to office furniture. More specifically, the present invention relates to office furniture having audio components integrated therein.

### BACKGROUND

Modern audio conferencing systems are standalone devices, such as a “conference room phone”, that are often placed on top of a conference table when in use. Such systems typically have power and communication lines extending therefrom, and thus can be awkward to move around from place to place. Another problem is that such systems may occupy space on a table top that is needed for other things. What is needed in the art is a way to provide conferencing capabilities around a table without the above-described disadvantages of standalone conferencing systems.

### SUMMARY

Disclosed herein is an office furniture system having audio conferencing components integrated therein. Thus, the table may have telephone conferencing capability without the need of additional devices such as standalone conferencing systems.

A user's mobile phone may serve as the conferencing device, and the audio system built into the table may serve as a sound reinforcement system. Thus, the invention may bring the functionality of connecting mobile devices to the table through a wireless or wired connection. The mobile devices may function as conference phones or media systems.

In one embodiment, the invention may provide a table having Bluetooth speaker connectivity. Thus, the table may be fully audio-compatible with additional Bluetooth devices (e.g., iPhone, Android etc.).

In some embodiments, the table has a speaker system that can operate in either a media mode or a conferencing mode. These modes may be automatically selected based on the Bluetooth connection that is established. The system may be able to switch between the two modes based on the audio frequency of the signal that is being carried by the system. For example, if music is played back through the table from a device in media mode, then high bandwidth with base may be selected and equalization may be automatically applied to compensate for room acoustics. Conversely, when the table is used for conferencing in conjunction with a speakerphone, the audio bandwidth may be reduced to about 4 KHz and mid-frequencies may be boosted to improve sound intelligibility. Typically three or four loudspeakers may be provided on a table.

One aspect of the present invention pertains to an office furniture conferencing system including a plurality of microphones attached to a table. Each microphone produces a respective audio signal. An electronic control module is attached to the table. The module includes a switching device having a plurality of inputs each receiving a respective one of the audio signals. The switching device selects and outputs one of the audio signals. A wireless transmitter is communicatively coupled to the switching device. The wireless transmitter wirelessly transmits an airborne signal dependent upon the selected audio signal.

Another aspect of the present invention pertains to an office furniture conferencing method, including providing a table having a plurality of microphones, a loudspeaker, and a control module attached thereto. The microphones and loudspeaker are communicatively coupled to the control module. A respective audio signal is produced from each microphone.

One of the audio signals is automatically selected by use of the control module. A first airborne signal is wirelessly transmitted dependent upon the selected audio signal. The transmitting is performed by the control module. A second airborne signal is wirelessly received from a personal mobile device that received the first airborne signal. The personal mobile device is disposed within fifty feet of the table. The receiving is performed by the control module. The personal mobile device is identified by the control module. Audible sounds are played on the loudspeaker dependent upon the second airborne signal. The playing occurs after the identifying step and is performed by the control module. It is determined that a wireless communication link between the control module and the personal mobile device is broken. The determining is performed by the control module. In response to the determining step, playing of any audible sound that is dependent upon an airborne signal from the personal mobile device is inhibited until the control module re-identifies the personal mobile device.

A further aspect of the present invention pertains to an office furniture conferencing system including a plurality of microphones associated with a table. Each microphone produces a respective audio signal. A switching device is attached to the table and has a plurality of inputs each receiving a respective one of the audio signals. The switching device outputs a switcher signal dependent upon the audio signals. A wireless transmitter is attached to the table and is communicatively coupled to the switching device. The wireless transmitter wirelessly transmits a Bluetooth signal dependent upon the switcher signal.

### BRIEF DESCRIPTION OF THE DRAWINGS

FIG. 1 is a block diagram of an audio conferencing system for office furniture according to one embodiment of the present invention.

FIG. 2 is a flow chart illustrating one embodiment of a method of the present invention for operating the audio conferencing system of FIG. 1.

### DESCRIPTION

For the purpose of promoting an understanding of the principles of the present embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

Generally, the present system, method, and apparatus provide a table having conferencing capabilities. While the figures herein illustrate one specific implementation, the invention as illustrated will be adapted and modified by those skilled in the art as will occur to them in view of the present disclosure.

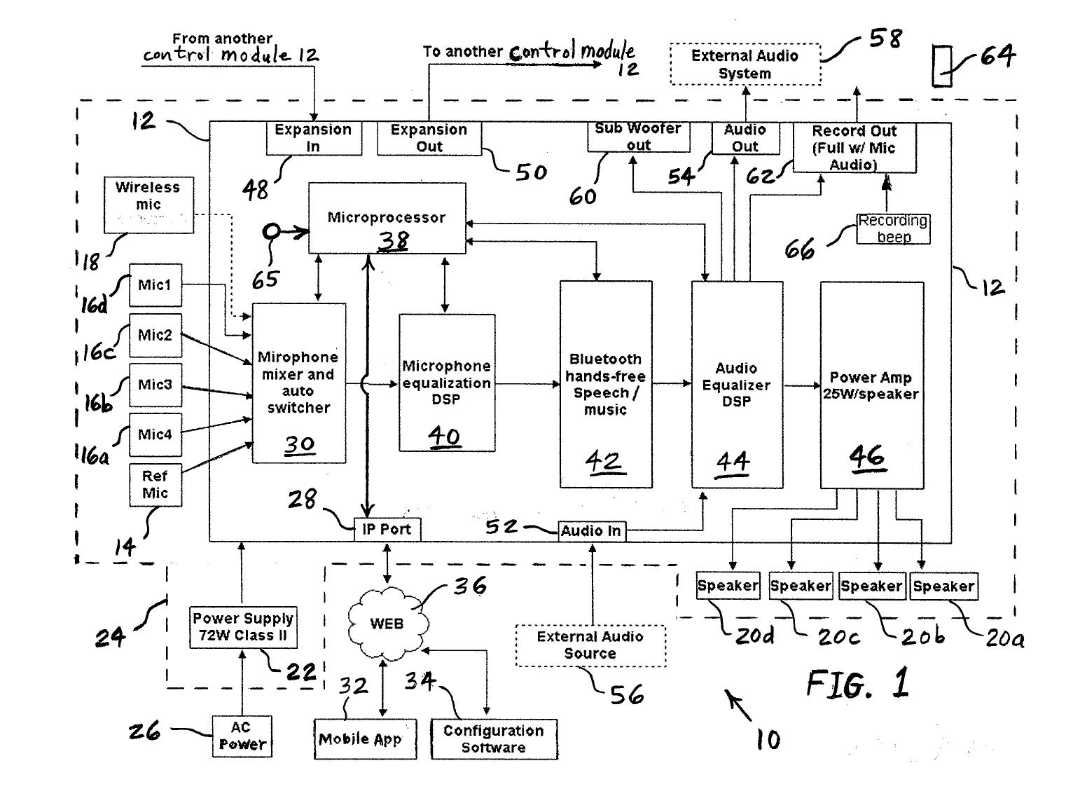

FIG. 1 illustrates one embodiment of an audio conferencing system 10 of the present invention including a control module 12 all the components of which may be in a common box-shaped housing measuring approximately ten inches by ten inches by two inches. Control module 12 along with reference microphone 14, voice microphones 16a-d, wireless microphone 18, loudspeakers 20a-d, and power supply 22 may be attached to a same conference table 24. Microphones 14, 16a-d and 18 may be mounted below the tabletop or surface of table 24 within a common housing (not shown), and may be physically separated from the table by some type of isolation pad (not shown) in order to prevent any feedback from items or movement disposed above the tabletop. Reference microphone 14 may be installed at a location on table 24 that is unlikely, or least likely, to pick up the voices of users speaking into voice microphones 16a-d. Thus, reference microphone 14 may primarily pick up background noise in the room. The isolated background noise signal from reference microphone 14 may be used in a noise cancellation process applied to the audio signals produced by voice microphones 16a-d.

Power supply 22 may receive AC power 26 from a standard wall-mounted receptacle which may provide standard household voltage of approximately between 110 volts and 120 volts.

Control module 12 may include an internet protocol (IP) port 28 which enables configuration of module 12, including microphone mixer and auto switcher 30 by a mobile application 32 or by configuration software 34 via an Ethernet connection or a CAT5 network cable to the Internet 36. Thus, the user can use, for example, his laptop computer to connect to an audio processor which includes switcher 30, microprocessor 38, microphone equalization digital signal processor (DSP) 40, Bluetooth hands-free speech/music module 42, audio equalizer digital signal processor (DSP) 44, and power amplifier 46. Through this connection to the audio processor, the user may use his laptop to configure microphones 14, 16a-d, 18, speakers 20a-d, microphone equalization settings, output equalizations settings and any other settings as desired. These settings may be established to accommodate the particular acoustic characteristics of the room in which table 24 is disposed, for example. The laptop computer may include a graphical interface that shows the equalizer settings. Alternatively, a wireless Bluetooth personal electronic device may be used to establish the settings.

IP port 28 may also be used within the organization to track assets, such as system 10 and the table 24 to which system 10 is attached. When system 10 is connected to a common network, the information technology department of the organization can monitor the status of system 10 and remotely provide proactive service or repair.

The expanding ports (i.e., expansion in port 48 and expansion out port 50) can be used to daisy chain multiple control modules 12 together and thus expand system 10. In particular, ports 48, 50 may be used to interconnect processors 38 of multiple control modules 12. This may enable easy integration of the system on a long table with a large number of people wherein more than four microphones are needed. One control module 12 may act as the master, and the other control modules 12 may act as slaves.

An external audio in port 52 and an external audio out port 54 may enable integration of the table with other audio equipment, such as an external audio source 56 and an external audio system 58, respectively. Thus, third party installers can further integrate system 10 with different amplifiers or microphones (not shown). A laptop computer may serve as the external audio source 56, for example.

A sub-woofer out port 60 may enable the integration of a sub-woofer (not shown) for lower audio frequencies (e.g., bass).

A record out (full with microphone audio) port 62 may enable a digital storage device (not shown), such as a hard drive, to be integrated with system 10 to enable the recording of audio or sounds that take place in the vicinity of the table 24 on which system 10 is installed. Thus, port 62 may enable recording of audio or sounds from parties in the room in which system 10 is disposed and audio or sounds on the remote end of telecommunication involving a user's mobile phone 64. Table 24 may include a visible light emitting diode (not shown) of a certain color (e.g., red) that lights up when recording is occurring.

A Bluetooth enabled mobile phone 64 may bi-directionally communicate with system 10 via Bluetooth hands-free speech/music module 42. A pushbutton 65, a touchbutton or other type of switch may be communicatively coupled to processor 38, and may be actuated by a user in order to initiate a communication link between control module 12 and cell phone 64 (e.g., a Bluetooth communication link between Bluetooth module 42 and cell phone 64). Control module 12 may prompt the user of cell phone 64 to agree to establish the communication link, for example by transmitting a message to cell phone 64 asking “Do you want to connect to the conference?” The user of cell phone 64 may confirm his desire for cell phone 64 to be connected to system 10, such as by entering one or more keystrokes into cell phone 64. Table 24 may include a visible light emitting diode (not shown) of a certain color (e.g., blue) that lights up when control module 12 is searching for a cell phone or other Bluetooth device to communicate with, or when the device has been found and pairing is occurring.

A recording beep module 66 may add an intermittent beep sound to the audio signal transmitted on port 62 in order to give an audible indication to all involved parties that a recording of the conversation or other audio source is taking place.

Microphones 14, 16a-d and 18 are fed into microphone mixer and auto switcher 30 that includes an audio mixer having an automatic switch which may automatically select the strongest one of the microphone signals coming from microphones 14, 16a-d and 18. The microphones other than the one emitting the strongest signal may then be muted. Thus, in this embodiment, system 10 may be said to focus on the loudest speech in order to enable audio conferencing of the best audio quality. The selected microphone with the strongest signal may be equalized to provide neutral audio, and the signal may then be fed to the Bluetooth device 42. Bluetooth device 42 may then transmit the signal to cell phone 64 for cellular transmission to the cell phones (not shown) of other remote conference attendees. Bluetooth device 42 may also provide echo cancellation and feedback cancellation.

The output from Bluetooth device 42 may be equalized by audio equalizer DSP 44 and fed to power amplifier 46 to drive speakers 20a-d, which may be located under the tabletop.

During use, system 10 may operate in a conference mode or in a media mode. In the conference mode, the table equipment of system 10 may support local voice input through a series of embedded microphones 14, 16a-d and 18 which may be connected to the Bluetooth receiver 42 through the audio mixer of module 30. System 10 may support remote voice input through the microphones of the remote participants' cell phones, which may be in communication with the audio mixer of module 30 through Bluetooth receiver 42. System 10 may intelligently shut off the remote participant's mobile device's microphone, which may operate as a hands-free application when connected and used in conference mode. Thus, the mixer 30 may intelligently devote the maximum amount of focus to who is speaking, increasing the gain of the speaker's microphone and scaling back the gain of the other microphones, and thereby reducing interference.

In the media mode (e.g., presentations, web video, etc.) system 10 may intelligently switch to a higher audio bandwidth. To this end, in one embodiment, system 10 may connect a tablet computer or laptop computer tethered by a high-definition multimedia interface (HDMI) to improve audio quality. The audio signal and the video signal may be separated, keeping the audio signal locally within the table 24, and an HDMI (video) out connection may be provided on table 24.

Video connection in/out ports (not shown) may be supported but treated separately. When a “tethered connection” is used, system 10 may not allow any wireless connections, thereby reducing the chance of any interference.

Both wireless and wired/tethered types of connections may be available and supported by system 10. In the case of a wireless connection, the user may be able to simply use the mobile device's native Bluetooth capability and connect system 10 to the mobile device in order to place phone calls or share audio signal though the table. This Bluetooth connection may operate in an inventive “forget me” type application wherein when the user is finished with using the table and disconnects his cell phone from system 10 or walks his cell phone out of the communication range of system 10, a new connection between the cell phone and system 10 will have to be established in order for his cell phone and system 10 to again communicate. This re-establishing of the communication link between the cell phone and system 10 may be called for each time the cell phone is disconnected from system 10 or is moved out of the communication range of system 10. This feature may advantageously ensure any devices that have been previously connected to system 10 do not interfere with any current connection. For example, it would be undesirable for a former conference call participant to leave the table, access a music stream on his mobile device, and then physically return within communication range of system 10, which could result in the music stream being inadvertently transmitted to the current conference call participants who are using system 10. Thus, system 10 may permit only one Bluetooth connection to be established at a time.

In the case of a wired/tethered connection, a user may be able to connect to the table 24 using an HDMI connection. The system may separate the video signals and audio signals, keeping the audio signals locally on the table 24. A user may be able to transmit the video media content to a display that is not a part of the system. The system may support a single user with an HDMI out connection.

System 10 may accommodate iPhone operating system (iOS) devices as well as Android and other devices through these devices' native Bluetooth applications. All of these various types of devices may also be able to connect to system 10 via a tethered HDMI cable specific to the particular device. In one embodiment, the inventive system may be able to support an iOS application that connects to and controls the web browser for the system. Thus, a user's mobile device may be used to control the inventive system to switch modes, place calls, set up the system, or perform maintenance.

During the setting up and testing of system 10, the audio output may be adjusted based on the interior attributes of the room in which the table 24 is to be operated. These adjustments may be performed by actuation of manual switches (not shown) on the table 24 or by connecting system 10 to a network, logging in through a web interface, and adjusting the audio levels. The user(s) logging in may be able to see some type of diagnostics on a display screen which guide the user towards selecting the best audio setting. For example, system 10 may play back some predefined sound bites and the user interface of system 10 may simultaneously display indications of the actual sound levels that are being picked up and registered by microphones 14, 16a-d and 18. The user may also be able to walk around the table 24 and test the microphone input through the user interface, thereby verifying that mixer and switcher 30 is functioning properly.

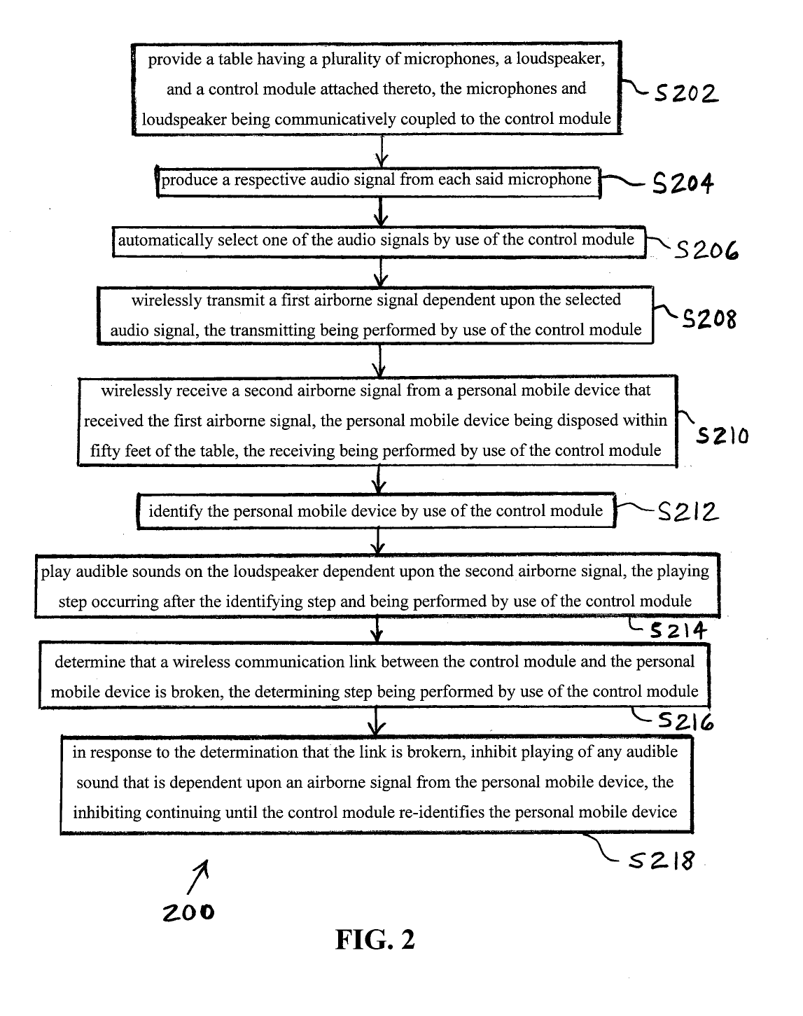

One embodiment of an office furniture conferencing method 200 of the present invention is illustrated in FIG. 2. In a first step S202, a table having a plurality of microphones, a loudspeaker, and a control module attached thereto is provided. The microphones and loudspeaker are communicatively coupled to the control module. For example, microphones 14, 16a-d and 18, loudspeakers 20a-d, and control module 12 are attached to table 24. Further, microphones 14, 16a-d and 18, loudspeakers 20a-d are communicatively coupled to control module 12.

In a next step S204, a respective audio signal is produced from each microphone. That is, each of microphones 14, 16a-d and 18 may output its own respective signal based upon the sounds that the microphone picks up in its particular location. Because the distance to a source of sound (e.g., a human voice) may vary from microphone to microphone, the strength of magnitude of the signal produced by each microphone may also vary.

Next, in step S206, one of the audio signals is automatically selected by use of the control module. For example, microphone mixer and automatic switcher 30 may determine which of microphones 16a-d and 18 is outputting the strongest or highest magnitude signal, and may select that strongest signal, perhaps on the assumption that the strongest signal is easiest to process such that it can be heard and deciphered by users listening on cell phone 64 and other personal mobile electronic devices. The strongest signal may further be assumed to have the highest signal-to-noise ratio, wherein the signal represents a speaker's voice, and the noise represents background noise. The output of reference microphone 14 may not be considered for selection, as it may be positioned such that it is unlikely to be closest to a human speaker, and thus its output signal would be mostly noise in the event that its output signal is the strongest put out by any of the microphones.

In step S208, a first airborne signal dependent upon the selected audio signal is wirelessly transmitted. The transmitting is performed by use of the control module. In the particular embodiment of FIG. 1, Bluetooth hands-free speech/music module 42 may wirelessly transmit the selected microphone signal after the signal has been processed by DSP 40.

In a next step S210, a second airborne signal is wirelessly received from a personal mobile device that received the first airborne signal. The personal mobile device is disposed within fifty feet of the table. The receiving is performed by use of the control module. Again, in the particular embodiment of FIG. 1, a user of system 10, who may be sitting at table 24, may be carrying a cell phone 64 that receives the Bluetooth signal transmitted from module 42. Cell phone 64 may be used as a remote conferencing device that relays the content of the received Bluetooth signal to the cell phone (not shown) of a remotely located conference participant. The remote participant may speak into his cell phone, and the resulting cellular signal may be transmitted to cell phone 64, as is well known. Cell phone 64 may then relay the received cellular signal as a Bluetooth signal to Bluetooth hands-free speech/music module 42, which receives the Bluetooth signal as part of control module 12.

Next, in step S212, the personal mobile device is identified by use of the control module. For example, control module 12, though Bluetooth module 42, may request or otherwise receive identifying information from cell phone 64, such as an authentication code. Control module 12 may permit only one cell phone at a time to function as a conference transceiver, and module 12 may use the identification information to verify that Bluetooth signals received in the near future during the same conferencing session (e.g., within the next few hours) originate from the same cell phone 64. In one embodiment, Bluetooth signals received from cell phones other than the identified cell phone are ignored, or at least are not processed by control module 12.

In step S214, audible sounds dependent upon the second airborne signal are played on the loudspeaker. The playing occurs after the personal mobile device is identified in step S212 and is performed by use of the control module. That is, after Bluetooth module 42 has received the Bluetooth signal from cell phone 64, and control module 12 has identified cell phone 64, control module 12 may play the Bluetooth signal from cell phone 64, which may be the voice of the remote conference participant, on one or more of loudspeakers 20a-d.

In a next step S216, it is determined that a wireless communication link between the control module and the personal mobile device is broken. The determination is performed by the control module. For example, the user who carries cell phone 64 may manually disconnect cell phone 64 from the conference call and from control module 12. As another example, the user who carries cell phone 64 may walk away from table 24 a distance large enough that the Bluetooth connection between control module 12 and cell phone 64 is lost. By monitoring the continuous or at least intermittent Bluetooth signals from cell phone 64, Bluetooth module 42 may detect when its communication link with cell phone 64 is no longer useful or no longer works.

In a final step S218, in response to the determination in step S216 that the wireless communication link between the control module and the personal mobile device is broken, playing of any audible sound that is dependent upon an airborne signal from the personal mobile device is inhibited until the control module re-identifies the personal mobile device. For example, upon Bluetooth module 42 detecting that its communication link with cell phone 64 is broken, control module 12 may refrain from playing any sounds on loudspeakers 20a-d that would result from subsequent wireless signals that control module 12 receives from cell phone 64. Thus, in the example scenario in which the owner of cell phone 64 walks away from table 24 and thereby loses his connection with control module 12, begins another telephone call with someone who did not participant in the prior conference, and then walks back into Bluetooth communication range with control module 12, control module 12 will not play his new conversation on loudspeakers 20a-d. However, if cell phone 64 is again registered with control module 12, or otherwise identified as a device that is to be connected to control module 12, then control module 12 may again play audible sounds that are dependent upon airborne signals received from cell phone 64. Control module 12 may require an authentication code from cell phone 64, possibly the same authentication code as received initially or another authentication code, before control module 12 will again play audible sounds that are dependent upon airborne signals received from cell phone 64.

Control module 12 may transmit to cell phone 64 one or more authentication codes when a communication link is first established between control module 12 and cell phone 64. A user of cell phone 64 may need to positively indicate on cell phone 64 that he would like cell phone 64 to be connected to, or re-connected to, control module 12, such as by a series of keystrokes. After the user of cell phone 64 has thus indicated that he would like cell phone 64 to be connected to, or re-connected to, control module 12, cell phone 64 may begin automatically and intermittently transmitting Bluetooth signals carrying the authentication code.

Although the steps of method 200 may have been described above as occurring in a certain order, it is to be understood that it is within the scope of the invention for the steps to occur in different orders than as illustrated.

The inventive system may enable transparent integration of a cell phone into the boardroom environment. To the degree that the above description includes integration of only the audio portion of the phone, it is to be understood that the invention may also include integration of the video portion of the phone.

The invention has been described as using a Bluetooth protocol in communication between control module 12 and cell phone 64. However, it is to be understood that it is possible for other wireless protocols to be used in communication between the system of the invention and a mobile electronic device.

Other combinations and arrangements will occur to those skilled in the art in view of the present disclosure. All publications, prior applications, and other documents cited herein are hereby incorporated by reference in their entirety as if each had been individually incorporated by reference and fully set forth. While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed:

1. An office furniture conferencing system comprising:
a table;
a plurality of microphones attached to the table, each microphone being configured to produce a respective audio signal; and
an electronic control module attached to the table, the module including:
a switching device having a plurality of inputs each configured to receive a respective one of the audio signals, the switching device being configured to:
select one of the audio signals; and
output the selected audio signal; and
a wireless transmitter communicatively coupled to the switching device, the wireless transmitter being configured to wirelessly transmit an airborne signal dependent upon the selected audio signal.

2. The system of claim 1, wherein the wireless transmitter comprises a Bluetooth transmitter.

3. The system of claim 1, further comprising a loudspeaker attached to the table, the electronic control module including a wireless receiver configured to receive a second airborne signal from a personal mobile device disposed in a vicinity of the table, the control module being configured to play the second airborne signal on the loudspeaker.

4. The system of claim 3, wherein the wireless receiver comprises a Bluetooth receiver.

5. The system of claim 3, wherein the control module is configured to:
identify the personal mobile device before playing the second airborne signal on the loudspeaker; and
if a wireless communication link between the control module and the personal mobile device is broken, inhibit playing of any airborne signal from the personal mobile device until the control module re-identifies the personal mobile device.

6. The system of claim 3, further comprising a switch attached to the table and communicatively coupled to the control module, the control module being configured to initiate communication link with the personal mobile device in response to actuation of the switch.

7. The system of claim 1, wherein the system is expandable by communicatively coupling the electronic control module to another electronic control module attached to an adjacent table.

8. The system of claim 1, wherein the electronic control module includes an internet protocol port, the electronic control module being configured to enable a user to establish microphone equalization settings via the internet protocol port.

9. An office furniture conferencing method, comprising the steps of:
providing a table having a plurality of microphones, a loudspeaker, and a control module attached thereto, the microphones and loudspeaker being communicatively coupled to the control module;
producing a respective audio signal from each said microphone;
automatically selecting one of the audio signals by use of the control module;
wirelessly transmitting a first airborne signal dependent upon the selected audio signal, the transmitting being performed by use of the control module;
wirelessly receiving a second airborne signal from a personal mobile device that received the first airborne signal, the personal mobile device being disposed within fifty feet of the table, the receiving being performed by use of the control module;
identifying the personal mobile device by use of the control module;
playing audible sounds on the loudspeaker dependent upon the second airborne signal, the playing step occurring after the identifying step and being performed by use of the control module;
determining that a wireless communication link between the control module and the personal mobile device is broken, the determining step being performed by use of the control module; and
in response to the determining step, inhibiting playing of any audible sound that is dependent upon an airborne signal from the personal mobile device, the inhibiting continuing until the control module re-identifies the personal mobile device.

10. The method of claim 9, wherein the wireless transmitter comprises a Bluetooth transmitter.

11. The method of claim 9, further comprising a loudspeaker attached to the table, the electronic control module including a wireless receiver configured to receive a second airborne signal from a personal mobile device disposed in a vicinity of the table, the control module being configured to play the second airborne signal on the loudspeaker.

12. The method of claim 9, wherein the wireless receiver comprises a Bluetooth receiver.

13. The method of claim 9, wherein the system is expandable by communicatively coupling the electronic control module to another electronic control module attached to an adjacent table.

14. The method of claim 9, wherein the electronic control module includes an internet protocol port, the electronic control module being configured to enable a user to establish microphone equalization settings via the internet protocol port.

15. The method of claim 9, wherein the inhibiting continues until the control module receives an authentication code from the personal mobile device.

16. An office furniture conferencing system comprising:
a table;
a plurality of microphones associated with the table, each microphone being configured to produce a respective audio signal;
a switching device attached to the table and having a plurality of inputs each configured to receive a respective one of the audio signals, the switching device being configured to output a switcher signal dependent upon the audio signals; and
a wireless transmitter attached to the table and communicatively coupled to the switching device, the wireless transmitter being configured to wirelessly transmit a Bluetooth signal dependent upon the switcher signal.

17. The system of claim 16, further comprising:
a loudspeaker attached to the table;
a wireless receiver attached to the table and configured to receive a second airborne signal from a personal mobile device disposed in a vicinity of the table, the loudspeaker being configured to play the second airborne signal.

18. The system of claim 17, further comprising a processor attached to the table and configured to:
identify the personal mobile device before playing the second airborne signal on the loudspeaker; and
if a wireless communication link between the processor and the personal mobile device is broken, inhibit playing of any airborne signal from the personal mobile device until the processor re-identifies the personal mobile device.

19. The system of claim 18, wherein the system is expandable by communicatively coupling the processor to another processor attached to an adjacent table.

20. The system of claim 18, further comprising an internet protocol port attached to the table, the internet protocol port being configured to carry microphone equalization settings input by a user.
